(19) United States
(12) Patent Application Publication
(10) Pub. No.: US 2026/0290138 A1
(43) Pub. Date: Sep. 24, 2026

(54) SYSTEMS, METHODS, AND STORAGE MEDIA FOR EMERGENCY WARNING OF ROAD ICING BASED ON INTERNET OF THINGS (IOT) LARGE MODELS

(71) Applicant: CHENGDU QINCHUAN IOT TECHNOLOGY CO., LTD., Chengdu (CN)

(72) Inventors: Hanshu SHAO, Chengdu (CN); Junyan ZHOU, Chengdu (CN)

(73) Assignee: CHENGDU QINCHUAN IOT TECHNOLOGY CO., LTD., Chengdu (CN)

(21) Appl. No.: 19/690,204

(22) Filed: May 28, 2026

(30) Foreign Application Priority Data
Apr. 23, 2026 (CN) 202610542656.9

(51) Int. Cl. G08B 19/02; E01H 10/00; G01S 15/88; G06Q 50/26

(52) U.S. Cl. CPC G08B 19/02; E01H 10/007; G01S 15/88; G06Q 50/265

(57) ABSTRACT

A system, a method, and a storage medium for emergency warning of road icing based on an Internet of Things (IoT) large model are provided. The method comprises: obtaining multi-source monitoring data of a target road; determining an icing risk sequence based on the multi-source monitoring data, a road surface material, road elevation information, and slope information; determining a deicing parameter for the target road; controlling an automatic deicing vehicle to travel to the target road, measuring a pre-deicing ice thickness, and uploading the pre-deicing ice thickness back to an emergency supervision and management platform; and, controlling the automatic deicing vehicle to spread a deicing agent on the target road, and controlling a road condition information display at an entrance of the target road to display warning information.

### CROSS-REFERENCE TO RELATED APPLICATIONS

This application claims priority to Chinese Patent Application No. 202610542656.9, filed on Apr. 23, 2026, the entire contents of which are hereby incorporated by reference.

### TECHNICAL FIELD

The present disclosure relates to the field of road emergency warning, and in particular to a system, a method, and a non-transitory computer-readable storage medium for emergency warning of road icing based on an Internet of Things (IoT) large model.

### BACKGROUND

With the surge in transportation demand, road icing has become a major threat to traffic safety. Road icing not only causes a sharp drop in coefficients of friction of a road surface, but is also prone to cause chain accidents within a short period, posing a risk of paralysis to an urban traffic network.

Conventional systems for emergency warning of road icing typically rely on manual inspection or a single sensor network to detect road icing, and usually perform deicing operations only after ice formation occurs. The conventional systems lack intelligent prior perception and processing capabilities, making it difficult to meet the real-time and intelligent requirements of modern smart cities for deicing operations.

Therefore, it is desirable to provide a system, a method, and a storage medium for emergency warning of road icing based on an IoT large model, which can accurately and effectively improve a response speed to urban road icing and perform deicing operations in a timely manner.

### SUMMARY

One or more embodiments of the present disclosure provide a system for emergency warning of road icing based on an IoT large model, comprising an emergency supervision and management platform, wherein the emergency supervision and management platform is configured to execute a method for emergency warning of road icing.

One or more embodiments of the present disclosure provide a method for emergency warning of road icing. The method comprises: acquiring multi-source monitoring data of a target road; determining an ice formation risk sequence of the target road based on the multi-source monitoring data, a road surface material, road elevation information, and slope information; determining a deicing parameter for the target road based on the ice formation risk sequence, wherein the deicing parameter includes a type, a spreading amount, and a spreading rate of a deicing agent; based on the deicing parameter, controlling an automatic deicing vehicle to travel to the target road, measuring a pre-deicing ice thickness by transmitting an acoustic wave and receiving echoes via an ultrasonic probe of the automatic deicing vehicle, and uploading the pre-deicing ice thickness back to an emergency supervision and management platform; and, controlling the automatic deicing vehicle to spread the deicing agent on the target road based on the deicing parameter, and controlling a road condition information display at an entrance of the target road to display warning information.

One or more embodiments of the present disclosure provide a non-transitory computer-readable storage medium. The storage medium stores computer instructions, and when a computer reads the computer instructions in the storage medium, the computer executes the method for emergency warning of road icing based on an IoT large model.

### BRIEF DESCRIPTION OF THE DRAWINGS

The present disclosure will be further elucidated by way of exemplary embodiments, which are described in detail with reference to the accompanying drawings. These embodiments are not limiting. In these embodiments, the same reference numerals denote the same structures, wherein:

FIG. 1 is a block diagram illustrating an exemplary platform structure of a system for emergency warning of road icing based on an IoT large model according to some embodiments of the present disclosure;

FIG. 2 is a flowchart illustrating an exemplary process for emergency warning of road icing according to some embodiments of the present disclosure;

FIG. 3 is a schematic diagram illustrating an exemplary prediction model according to some embodiments of the present disclosure;

FIG. 4 is a schematic diagram illustrating update of a deicing parameter according to some embodiments of the present disclosure; and

FIG. 5 is a schematic diagram illustrating adjustment of a high-risk deicing parameter according to some embodiments of the present disclosure.

### DETAILED DESCRIPTION

To more clearly illustrate the technical solutions of the embodiments of the present disclosure, the accompanying drawings to be used in the description of the embodiments will be briefly described below. Obviously, the accompanying drawings in the following description are only some examples or embodiments of the present disclosure, and that the present disclosure may be applied to other similar scenarios in accordance with these drawings without creative labor for those of ordinary skill in the art. Unless obviously acquired from the context or the context illustrates otherwise, the same numeral in the drawings refers to the same structure or operation.

It should be understood that “system,” “device,” “unit,” and/or “module” as used herein is a way to distinguish between different components, elements, parts, sections, or assemblies at different levels. However, these words may be replaced by other expressions if they accomplish the same purpose. The term “and/or”, as used herein, is merely a way of describing the associative relationship of an associated object, indicating that three relationships may exist, e.g., A and/or B, which may be represented as: A alone, both A and B, and B alone.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Flowcharts are used in the present disclosure to illustrate the operations performed by the system according to some embodiments of the present disclosure. It should be understood that the operations described herein are not necessarily executed in a specific order. Instead, they may be executed in reverse order or simultaneously. Additionally, one or more other operations may be added to these processes, or one or more operations may be removed.

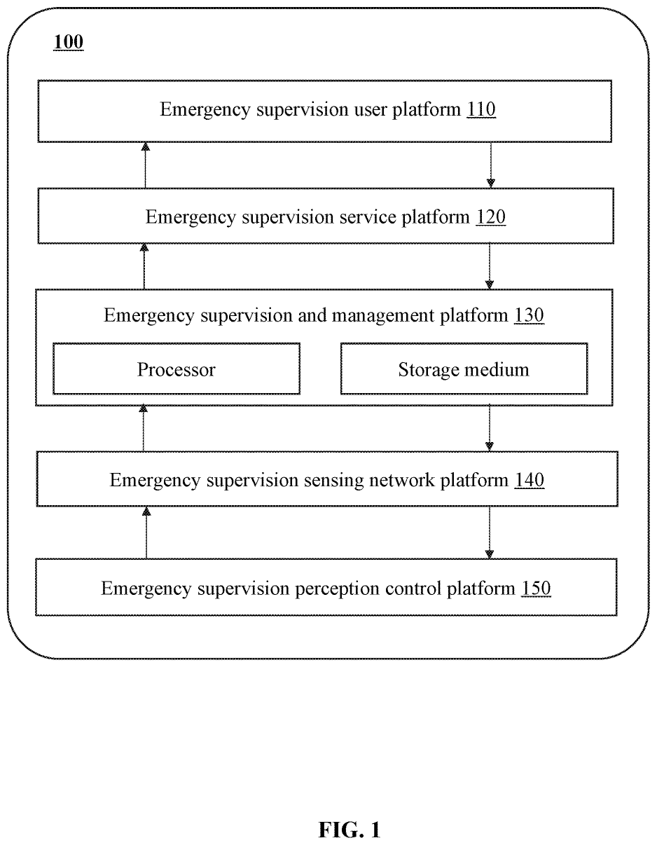

FIG. 1 is a block diagram illustrating a platform structure of a system for emergency warning of road icing based on an IoT large model according to some embodiments of the present disclosure.

In some embodiments, a system 100 for emergency warning of road icing based on an IoT large model may include an emergency supervision user platform 110, an emergency supervision service platform 120, an emergency supervision and management platform 130, an emergency supervision sensing network platform 140, and an emergency supervision perception control platform 150.

The emergency supervision user platform 110 is a platform for interacting with users. In some embodiments, the emergency supervision user platform 110 is configured as a terminal device. For example, the terminal device may be a mobile phone, a computer, and an application program or a web page installed on the computer.

In some embodiments, the emergency supervision user platform 110 performs information interaction with the emergency supervision service platform 120.

The emergency supervision service platform 120 is an interactive service platform for receiving and transmitting data.

In some embodiments, the emergency supervision service platform 120 may perform information interaction with the emergency supervision user platform 110 and the emergency supervision and management platform 130. For example, the emergency supervision service platform 120 may obtain a current weather condition, a speed limit value, a traffic volume limit value, a currently available lane, and other data from the emergency supervision and management platform 130, and send the data to the emergency supervision user platform 110. In some embodiments, the emergency supervision service platform 120 is configured as a server, a switch, or the like.

The emergency supervision and management platform 130 is a platform that converges all information of an Internet of Things (IoT) and provides perception management and control management functions for the IoT. In some embodiments, the emergency supervision and management platform 130 includes a processor and a storage medium. In some embodiments, the storage medium includes a hard disk drive, a storage array, or the like. The storage medium may be used for storing historical icing records, historical traffic data, or the like.

In some embodiments, the emergency supervision and management platform 130 may respectively perform information interaction with the emergency supervision service platform 120 and the emergency supervision sensing network platform 140. For example, the emergency supervision and management platform 130 may send the currently available lane, the speed limit value, and the traffic volume limit value to the emergency supervision service platform 120. As a further example, the emergency supervision and management platform 130 may send instructions for obtaining data such as road surface temperature and humidity to the emergency supervision sensing network platform 140, so as to obtain a road surface status of a target road.

The emergency supervision sensing network platform 140 may be a functional platform for managing sensing communication. In some embodiments, the emergency supervision sensing network platform 140 may implement functions of perception information sensing communication and control information sensing communication. For example, the emergency supervision sensing network platform 140 may receive multi-source monitoring data from the emergency supervision perception control platform 150, and upload the received multi-source monitoring data to the emergency supervision and management platform 130. The emergency supervision sensing network platform 140 may further receive a deicing parameter and a deicing path from the emergency supervision and management platform 130, and send the deicing parameter and the deicing path to the emergency supervision perception control platform 150, so as to control an automatic deicing vehicle to perform a deicing operation on the target road.

In some embodiments, the emergency supervision sensing network platform 140 includes router gateways and other communication devices.

The emergency supervision perception control platform 150 refers to a platform for emergency supervision data acquisition and implementing instructions. In some embodiments, the emergency supervision perception control platform 150 includes an automatic deicing vehicle and a plurality of emergency supervision object sub-platforms. The emergency supervision object sub-platforms are configured as Roadside Unit (RSU) units, temperature and humidity sensors, or the like. The plurality of emergency supervision object sub-platforms may be respectively configured on two sides of a road, on a road surface, and in an environment surrounding the road, to acquire multi-source monitoring data, and upload the acquired multi-source monitoring data to the emergency supervision and management platform 130 via the emergency supervision sensing network platform 140.

In some embodiments of the present disclosure, the system for emergency warning of road icing based on the IoT large model can facilitate data and information exchange among various functional platforms, forming a closed-loop information operation. Under the unified management of the emergency supervision and management platform, the system operates in a coordinated and regular manner, enabling the efficient and automatic operation of automatic de-icing vehicles. This can accurately and effectively improve the response speed to urban road icing and carry out de-icing operations in a timely manner.

It should be noted that the above description of the system for emergency warning of road icing based on the IoT large model is merely for convenience of description, and should not limit the present disclosure to the scope of the illustrated embodiments. It may be understood that for a person having ordinary skill in the art, after understanding the principle of the system, without departing from the principle, various modules may be arbitrarily combined, or a sub-system may be formed and connected to other modules. In some embodiments, the emergency supervision user platform 110, the emergency supervision service platform 120, the emergency supervision and management platform 130, the emergency supervision sensing network platform 140, and the emergency supervision perception control platform 150 disclosed in FIG. 1 may be different platforms in the system, or one platform may implement the functions of the above-mentioned two or more platforms. For example, the various platforms may share a storage module, and the various modules may also respectively have their respective storage modules. Such variations are all within the protection scope of the present disclosure.

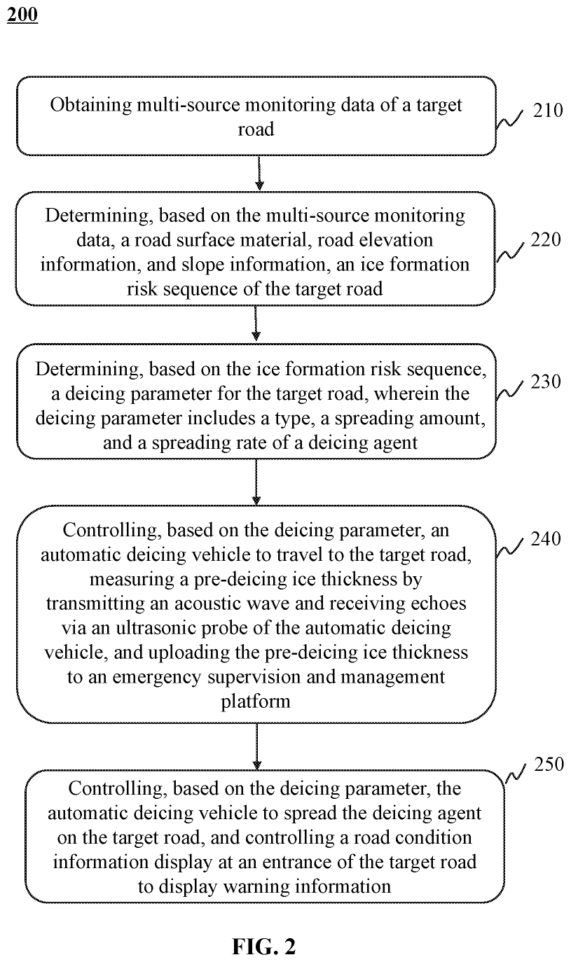

FIG. 2 is a flowchart illustrating an exemplary process for emergency warning of road icing according to some embodiments of the present disclosure. As shown in FIG. 2, a process 200 includes the following steps. In some embodiments, the process 200 may be executed by the emergency supervision and management platform 130.

Step 210, obtaining multi-source monitoring data of a target road.

The target road refers to a road for which an ice formation risk needs to be monitored and deicing needs to be performed.

The target road may be determined in a plurality of manners. For example, the emergency supervision and management platform may determine a road whose historical icing occurrences exceed a preset occurrence threshold as the target road. As another example, the emergency supervision and management platform may determine a user-specified road as the target road.

In some embodiments, the target road is represented as a sequence formed by a plurality of road segments, for example, [‘road segment 1’, ‘road segment 2’, . . . , ‘road segment n’]. The emergency supervision and management platform may divide the target road into the plurality of road segments according to a preset length. The emergency supervision and management platform may also divide the target road into the plurality of road segments based on attribute features of the road (for example, a bridge, a fork, and a tunnel).

The multi-source monitoring data is comprehensive monitoring data collected through a plurality of channels and used for evaluating the ice formation risk. In some embodiments, the multi-source monitoring data may include meteorological data, cold source leakage data, road surface status data, real-time traffic data, historical icing records, or the like.

The meteorological data may reflect weather conditions in an area surrounding a road. For example, the meteorological data includes atmospheric temperature, atmospheric humidity, wind speed, a type of precipitation (e.g., rainstorm, thundershower, etc.), and a type of snowfall (e.g., light snow, snowstorm, etc.). The emergency supervision and management platform may obtain the meteorological data from a meteorological bureau or other departments.

The cold source leakage data is used to reflect a cold source leakage condition and an influence range thereof in the area surrounding the road. Since a road adjacent to a cold source has a lower temperature and is more prone to ice formation after rainfall or snowfall, a potential impact of the cold source on the icing risk needs to be considered. In some embodiments, the cold source leakage data includes a cold source leakage location, a type of leakage material (e.g., condensed ice, liquid nitrogen, etc.), a leakage source (e.g., a refrigerated truck, an industrial condenser, etc.), and a leakage radius. In some embodiments, the emergency supervision and management platform may obtain the cold source leakage data based on receiving a manual input or other means.

The road surface condition data may reflect a real-time condition of a road surface. In some embodiments, the road surface condition data includes a road surface temperature and a road surface humidity. The emergency supervision and management platform may obtain the road surface condition data via temperature and humidity sensors deployed on a surface of an urban road.

The real-time traffic data may reflect a traffic operation condition of the road. In some embodiments, the real-time traffic data includes a real-time traffic volume and a real-time average vehicle speed. The emergency supervision and management platform may obtain the real-time traffic data via Roadside Units (RSUs) installed on two sides of the road. The Roadside Unit may be integrated with a speedometer, a vehicle counter, and other devices.

An icing record is used to characterize an icing condition of the road. In some embodiments, the icing record includes an icing time and an iced road. The emergency supervision and management platform may obtain a currently iced road from a road management department in real time and store the currently iced road in a storage medium.

A historical icing record refers to an icing record accumulated and stored over a historical time period. In some embodiments, the emergency supervision and management platform may retrieve the historical icing record from a storage medium for analyzing a road icing pattern and predicting a potential ice formation risk.

In some embodiments, the multi-source monitoring data further includes a vegetation density on two sides of the target road. The vegetation density is acquired by a remote sensing satellite.

The vegetation density may reflect a degree of denseness of vegetation on the two sides of the road.

In some embodiments, the emergency supervision and management platform may determine the vegetation density based on a road overhead view image captured by the remote sensing satellite. For example, the emergency supervision and management platform may obtain the road overhead view image captured by the remote sensing satellite, identify a vegetation region and a road region in the road overhead view image via an image recognition model (e.g., a YOLO model, etc.), determine an area of the vegetation region and an area of the road region, respectively, and determine a ratio of the area of the vegetation region to the area of the road region as the vegetation density.

In some embodiments of the present disclosure, since the vegetation density on the two sides of the road affects a microenvironment of the road and alters an atmospheric temperature, an atmospheric humidity, and a wind speed in the area surrounding the road, introducing the vegetation density on the two sides of a road segment into the multi-source data effectively remedies a technical limitation of conventional prediction methods that rely only on macroscopic meteorological data while neglecting micro-environmental heterogeneity. This enables the emergency supervision and management platform to accurately identify a localized ice formation hazard caused by a difference in vegetation coverage, thereby significantly improving a spatial resolution of an ice formation risk assessment and a spatiotemporal sensitivity of a prediction result.

Step 220, determining, based on the multi-source monitoring data, a road surface material, road elevation information, and slope information, an ice formation risk sequence of the target road.

The road surface material may reflect a material type of the road surface. For example, the road surface material includes an asphalt pavement, a cement pavement, a gravel pavement, or the like.

The road elevation information may reflect a vertical spatial distribution characteristic of the road. For example, the road elevation information includes an altitude above sea level of different road segments.

The slope information may reflect an inclination degree of the road. For example, the slope information includes inclination types (e.g., an uphill road, a downhill road, a flat road segment) and inclination angles of the different road segments.

The ice formation risk sequence may reflect ice formation risks of different road segments. The ice formation risk sequence may be represented as [(road segment 1, ice formation risk 1), (road segment 2, ice formation risk 2), . . . , (road segment n, ice formation risk n)]. The ice formation risk is used to characterize an ice formation possibility of a road segment. A greater ice formation risk indicates a greater possibility of ice formation on the road segment.

In some embodiments, the emergency supervision and management platform may further determine the ice formation risk sequence via a prediction model.

The prediction model is a predictive model for determining an ice formation risk value. In some embodiments, the prediction model is a machine learning model, for example, any one or a combination of a Recurrent Neural Network (RNN) model, another customized model structure, or the like.

In some embodiments, an input of the prediction model includes the multi-source monitoring data, the road surface material, the road elevation information, and the slope information of the target road, and an output of the prediction model includes the ice formation risk sequence of the target road.

In some embodiments, the emergency supervision and management platform may preprocess the input of the prediction model. For example, the emergency supervision and management platform may perform dimensionless processing on the multi-source monitoring data, the road surface material, the road elevation information, and the slope information; perform one-hot encoding on discrete data; perform normalization processing on continuous data; and fuse multi-source and heterogeneous data, thereby providing a high-quality input for the prediction model.

In some embodiments, the emergency supervision and management platform may train an initial prediction model based on a first training set to obtain the prediction model.

In some embodiments, the first training set includes a large number of first training samples with first labels. A first training sample may include sample multi-source monitoring data, a sample road surface material, sample road elevation information, and sample slope information. The first label is a sample ice formation risk sequence corresponding to the first training sample.

The first training samples with the first labels may be obtained through a simulation experiment. For example, the emergency supervision and management platform may construct a sandbox environment containing a sample road segment in a physics simulation platform (e.g., COMSOL Multiphysics, etc.), determine an environment and weather within the sandbox based on the sample multi-source monitoring data, model the sample road segment within the sandbox based on the sample road surface material, the sample road elevation information, and the sample slope information, and perform the simulation experiment to obtain a simulated ice formation speed and a simulated ice formation thickness of the sample road segment. A sample ice formation risk may be positively correlated with the simulated ice formation speed and the simulated ice formation thickness, and when the road is completely free of ice, the sample ice formation risk is zero. By repeating the simulation experiment, a large number of first training samples with first labels may be obtained.

When training the prediction model, the emergency supervision and management platform inputs the first training sample into the initial prediction model, constructs a loss function based on an output of the initial prediction model and the first label, and iteratively updates a parameter of the initial prediction model based on the loss function until a preset condition is satisfied, at which point training ends and a trained prediction model is obtained. The preset condition may include, but is not limited to, convergence of the loss function, a training cycle reaching a threshold, or the like.

Step 230, determining a deicing parameter for the target road based on the ice formation risk sequence.

The deicing parameter may reflect a type of a deicing agent to be spread. In some embodiments, the deicing parameter may include the type of the deicing agent (e.g., a chloride salt deicing agent, an organic deicing agent, etc.), a spreading amount, and a spreading rate.

In some embodiments, the emergency supervision and management platform may determine the deicing parameter by querying a first vector database based on the ice formation risk sequence.

In some embodiments, the emergency supervision and management platform may construct the first vector database based on historical data, and determine the deicing parameter based on a matching vector retrieval. The first vector database includes a plurality of reference vectors with labels, and a label of a reference vector is a reference deicing parameter.

In some embodiments, the emergency supervision and management platform may construct a vector to be matched based on a total count of road segments of the target road and the ice formation risk sequence. There may be multiple ways to construct the vector to be matched. For example, the vector to be matched is constructed using manners such as One-Hot, Word2Vec, or the like.

In some embodiments, the emergency supervision and management platform may retrieve a plurality of historical deicing records with satisfactory deicing effects from a storage medium. For a particular historical deicing record, the emergency supervision and management platform may construct a reference vector based on a corresponding historical total count of road segments and a historical ice formation risk sequence, and determine a historical deicing parameter used in the historical deicing record as a label. By repeating this step, a plurality of reference vectors with labels are constructed. A construction manner of the reference vector is similar to that of a target vector. When a historical ice thickness after deicing is less than a preset thickness, the emergency supervision and management platform may consider that the deicing effect of the historical deicing record is satisfactory.

In some embodiments, the emergency supervision and management platform may determine the deicing parameter based on similarities between the vector to be matched and the plurality of reference vectors in the first vector database. For example, a reference vector having a similarity with the vector to be matched that satisfies a similarity preset condition is taken as a target vector, and a reference deicing parameter corresponding to the target vector is determined as the deicing parameter. The similarity preset condition includes a maximum similarity, a similarity greater than a preset threshold, or the like.

Step 240, controlling, based on the deicing parameter, an automatic deicing vehicle to travel to the target road, measuring a pre-deicing ice thickness by transmitting an acoustic wave and receiving echoes via an ultrasonic probe of the automatic deicing vehicle, and uploading the pre-deicing ice thickness to the emergency supervision and management platform.

In some embodiments, to accurately quantify the deicing effect of the deicing parameter and flexibly adjust the spreading amount according to an ice thickness of a current road segment, the emergency supervision and management platform may control the automatic deicing vehicle to travel to the target road, measure the pre-deicing ice thickness by transmitting an acoustic wave and receiving echoes via the ultrasonic probe of the automatic deicing vehicle, and upload the pre-deicing ice thickness back to the emergency supervision and management platform.

The automatic deicing vehicle is a work vehicle that performs a deicing operation. In some embodiments, the automatic deicing vehicle includes an autonomous driving module, a spreading device for spreading a deicing agent, and the ultrasonic probe for measuring an ice thickness.

In some embodiments, the emergency supervision and management platform may divide a road segment into a plurality of detection points based on a preset spacing. When the automatic deicing vehicle travels to a detection point, the emergency supervision and management platform controls the ultrasonic probe installed at a bottom of the automatic deicing vehicle to transmit an ultrasonic pulse toward a road surface, and receives a first echo reflected from an upper surface of the ice (i.e., an interface between the ice and air), and a second echo reflected from a lower surface of the ice (i.e., an interface between the ice and the road surface). The emergency supervision and management platform determines the ice thickness based on a time difference between the first echo and the second echo and an ultrasonic velocity in an ice layer.

Exemplarily, the emergency supervision and management platform may determine the ice thickness via Formula (1):

$$L = \frac{{T}_{2} - {T}_{1}}{2 \times V} \qquad ( 1 )$$

wherein L denotes the ice thickness, T₂ denotes a propagation duration of the second echo, T₁ denotes a propagation duration of the first echo, and V denotes the ultrasonic velocity in the ice layer.

In some embodiments, the emergency supervision and management platform may take a statistical value (e.g., an average value) of the pre-deicing ice thicknesses at different measurement locations of the road segment as the pre-deicing ice thickness of the road segment.

Step 250, controlling the automatic deicing vehicle to spread a deicing agent on the target road based on the deicing parameter, and controlling a road condition information display at an entrance of the target road to display warning information.

A deicing path is a travel path along which the automatic deicing vehicle performs a deicing operation.

In some embodiments, the emergency supervision and management platform may determine the deicing path in a variety of ways. For example, the emergency supervision and management platform may input the target road into a navigation system, and determine a travel path provided by the navigation system as the deicing path. As another example, the emergency supervision and management platform may determine a plurality of candidate deicing paths for the target road based on the ice formation risk sequence and a location of a supply station of the deicing agent; and determine the deicing path based on the plurality of candidate deicing paths, a service priority, and the real-time traffic data. For further description regarding determining the deicing path, see related content below.

In some embodiments, the emergency supervision and management platform may control the road condition information display at the entrance of the target road to display the warning information. For example, the emergency supervision and management platform may display, on the road condition information display, a lane where the deicing operation is currently being performed, a current deicing progress, a safe driving tip, and other information.

In some embodiments, the emergency supervision and management platform may further determine a traffic volume limit value and a speed limit value of the target road based on the pre-deicing ice thickness and a coefficient of friction of the target road; control, based on the traffic volume limit value and the speed limit value, a traffic signal device to limit a traffic volume and a speed for vehicles passing through the target road; and plan a dedicated deicing lane for the automatic deicing vehicle.

The coefficient of friction may reflect a slipperiness degree of a road segment surface. A smaller coefficient of friction indicates a smaller frictional force when a vehicle is traveling, and the vehicle is more prone to accidents such as skidding.

In some embodiments, the coefficient of friction is negatively correlated with the ice thickness and positively correlated with a road surface friction coefficient.

Exemplarily, the emergency supervision and management platform may determine the coefficient of friction via Formula (2):

$$η = {k}_{1} \times \frac{ψ}{L} , \qquad ( 2 )$$

wherein η denotes the coefficient of friction, L denote the ice thickness, W denotes the road surface friction coefficient, and k₁ is a coefficient, wherein a value of the coefficient k₁ may be preset based on prior experience. The emergency supervision and management platform may determine the friction coefficient ψ of different road segments by querying a material-friction coefficient table based on a road surface material of the different road segments. More descriptions regarding the road surface material may be found in related descriptions of FIG. 1.

In some embodiments, the emergency supervision and management platform may determine the traffic volume limit value and the speed limit value based on an actual ice thickness before spreading the deicing agent on the target road and the coefficient of friction.

The speed limit value refers to a maximum speed allowed for a vehicle to travel when a road is iced; and the traffic volume limit value refers to a maximum traffic volume allowed on the target road when the road is iced. In some embodiments, both the traffic volume limit value and the speed limit value are negatively correlated with the ice thickness, and positively correlated with the coefficient of friction.

Exemplarily, the emergency supervision and management platform may determine the traffic volume limit value ε and the speed limit value θ via Formula (3) and Formula (4), respectively:

$$ε = \overline{\overline{ε}} - {k}_{2} \times \frac{L}{η} \qquad ( 3 )$$

$$θ = \overline{\overline{θ}} - {k}_{3} \times \frac{L}{η} , \qquad ( 4 )$$

wherein L denote the ice thickness, η denotes the coefficient of friction, ε denotes the traffic volume limit value, ε̅denotes a maximum traffic volume allowed on the target road when the road is not iced, θ denotes the speed limit value, θ̅ denotes a maximum speed allowed for a vehicle to travel when the road is not iced, and k₂ and k₃ are coefficients, wherein values of the coefficients k₂ and k₃ may be preset based on prior experience.

In some embodiments, the emergency supervision and management platform may adjust, based on the traffic volume limit value and the speed limit value, a traffic signal device to limit a traffic volume and a speed for vehicles passing through the target road, and plan a dedicated lane for the deicing operation for the automatic deicing vehicle.

The traffic signal device is a traffic control device that displays warning information in real time and guides a traffic flow. The traffic signal device may include a traffic light, a lane indicator, a traffic sign board, or the like.

In some embodiments, the emergency supervision and management platform performs traffic volume limitation and speed limitation in a variety of ways. For example, when the target road requires traffic volume limitation, the emergency supervision and management platform may appropriately shorten a green light duration and extend a red light duration of the traffic light based on the traffic volume limit value, thereby achieving traffic volume limitation by reducing a proportion of the green light duration in a total duration. When the target road requires speed limitation, the emergency supervision and management platform may reduce a maximum vehicle speed displayed on the traffic sign board based on the speed limit value to limit the speed. The closer an average traffic volume currently on the target road is to the traffic volume limit value, the lower the proportion of the green light duration is.

In some embodiments, the emergency supervision and management platform plans the dedicated lane for the deicing operation for the automatic deicing vehicle. For example, the emergency supervision and management platform may determine a deicing lane corresponding to the deicing path, and switch a lane indicator of the deicing lane from a passable state to a no-passage state, thereby forming a dedicated deicing lane that only permits entry of the automatic deicing vehicle. After the automatic deicing vehicle departs from the deicing lane, the lane indicator is restored to allow normal passage of other vehicles.

In some embodiments of the present disclosure, the emergency supervision and management platform synchronously reduces the traffic volume limit value and the speed limit value based on a maximum ice thickness and a minimum coefficient of friction of the target road before spreading the deicing agent, and switches a lane signal of a selected lane to a red cross along an optimal deicing path to permit only passage of the automatic deicing vehicle. This reduces a traffic volume and a vehicle speed before the deicing operation, reduces a risk of rear-end collisions by following vehicles, and provides a closed operation space for the automatic deicing vehicle, thereby avoiding frequent lane changes or sudden braking, improving spreading continuity and operation safety, and achieving a closed-loop operation of traffic control and deicing coordination.

In some embodiments of the present disclosure, by fusing multi-source heterogeneous data such as meteorology, cold sources, and road surface sensing, and training to obtain a high-precision prediction model, an upgrade from conventional passive deicing to active prediction of an ice formation risk and automated deicing is achieved. This facilitates timely treatment of ice on a road, reduces an incidence rate of traffic accidents, and significantly enhances a safety assurance level of winter urban road traffic.

In some embodiments, the emergency supervision and management platform determines a plurality of candidate deicing paths for the target road based on the ice formation risk sequence and a location of a supply station of the deicing agent; and determines the deicing path based on the plurality of candidate deicing paths, a service priority, and the real-time traffic data.

The location of the supply station refers to a geographic location where the deicing agent is replenished and loaded for the automatic deicing vehicle.

A candidate deicing path refers to a deicing path to be selected.

In some embodiments, the emergency supervision and management platform sorts road segments of the target road in a descending order of ice formation risk based on the ice formation risk sequence, and selects road segments within a preset proportion range (e.g., top 50%) as road segments to be deiced. To ensure a deicing effect, the candidate deicing path needs to pass through at least all of the road segments to be deiced.

In some embodiments, the emergency supervision and management platform may generate the candidate deicing path in a variety of ways. For example, the emergency supervision and management platform may sort the road segments to be deiced in an ascending order of distance from the road segments to be deiced to the automatic deicing vehicle to obtain a sorted list. As another example, the emergency supervision and management platform may sort the road segments to be deiced in a descending order of ice formation risk to obtain a sorted list. The emergency supervision and management platform may control the automatic deicing vehicle to perform the deicing operation sequentially based on an order in the sorted list.

In some embodiments, since the automatic deicing vehicle can only carry a limited amount of the deicing agent, when a remaining amount of the deicing agent is insufficient to complete the deicing operation for a next road segment, the automatic deicing vehicle needs to go to a nearest supply station to replenish the deicing agent. Therefore, the emergency supervision and management platform may check the sorted list, determine whether the remaining amount of the deicing agent of the automatic deicing vehicle is sufficient to complete the deicing operation for the next road segment. If the remaining amount is insufficient, the emergency supervision and management platform may insert a supply station closest to a current road segment between the current road segment and the next road segment, until all of the road segments to be deiced are traversed, thereby forming a candidate deicing path.

Exemplarily, when the sorted list is [road segment 5→road segment 2→road segment 1→road segment 4→road segment 3], the emergency supervision and management platform may take road segment 5 as a starting point and road segment 3 as an ending point. When the emergency supervision and management platform finds that the remaining amount of the deicing agent is insufficient after the deicing operation for road segment 1, the emergency supervision and management platform may insert supply station A closest to road segment 1 between road segment 1 and road segment 4, to obtain a candidate deicing path [road segment 5→road segment 2→road segment 1→supply station A→road segment 4→road segment 3].

In some embodiments, by flexibly setting different sorting rules and performing distance sorting, service priority sorting, or a random sorting on the road segments to be deiced as described above, a plurality of sorted lists may be obtained, thereby generating the plurality of candidate deicing paths.

In some embodiments, the emergency supervision and management platform determines the deicing path based on the plurality of candidate deicing paths, a service priority, and the real-time traffic data.

The service priority is used to characterize an urgency degree of deicing for a road segment. A greater service priority indicates a higher urgency degree of deicing for the road segment. When the service priority for a road segment is zero, it indicates that the road segment does not require deicing.

In some embodiments, the emergency supervision and management platform may determine the service priority based on the ice formation risk of the road segment. For example, the higher a traffic volume of the road segment, the higher the service priority; when the road segment is a special road segment (e.g., an ambulance passage, an emergency lane, etc.) or a high-risk segment, the service priority is higher than that of an ordinary road segment. A specific evaluation rule for the service priority may be determined based on prior experience.

In some embodiments, the emergency supervision and management platform may determine a comprehensive score of the candidate deicing path, and determine the deicing path based on the comprehensive score.

The comprehensive score may reflect a degree of superiority of the candidate deicing path, and the higher the comprehensive score of a candidate deicing path, the better a deicing effect of the candidate deicing path.

In some embodiments, the comprehensive score includes a priority factor and a traffic volume factor. The priority factor is used to measure an impact of the service priority on the comprehensive score, and the traffic volume factor is used to measure an impact of the traffic volume on the comprehensive score.

Exemplarily, the emergency supervision and management platform may determine a priority factor an and a traffic volume factor an of a road segment n in the candidate path via Formula (5) and Formula (6), respectively:

$${α}_{n} = \frac{{Y}_{n} - {Y}_{B}}{{Y}_{T} - {Y}_{B}} \qquad ( 5 )$$

$${β}_{n} = \frac{{Z}_{n} - {Z}_{B}}{{Z}_{T} - {Z}_{B}} , \qquad ( 6 )$$

wherein αₙ is the priority factor of the road segment n, Yₙ is the service priority of the road segment n, Y_{B} is a minimum service priority among all road segments in the candidate path, Y_{T} is a maximum service priority among all the road segments in the candidate path; βₙ is the traffic volume factor of the road segment n, Zₙ is the traffic volume of the road segment n, Z_{B} is a minimum traffic volume among all the road segments in the candidate path, and Z_{T} is a maximum traffic volume among all the road segments in the candidate path. For further content regarding determining the service priority, see related description above, and for further content regarding determining the traffic volume, see related description of the RSU unit in FIG. 2.

In some embodiments, the comprehensive score of the road segment n is positively correlated with the priority factor and the traffic volume factor of the road segment n.

Exemplarily, the emergency supervision and management platform may determine a score Φₙ of the road segment n in the candidate path via Formula (7):

$${Φ}_{n} = {k}_{4} \times {α}_{n} + {k}_{5} \times {β}_{n} , \qquad ( 7 )$$

wherein Φₙ is the score of the road segment n, αₙ is the priority factor of the road segment n, βₙ is the traffic volume factor of the road segment n, and k₄ and k₅ are coefficients, wherein values of the coefficients k₄ and k₅ may be preset based on prior experience.

In some embodiments, the emergency supervision and management platform may perform a weighted sum of scores of all road segments in the candidate deicing path to determine the comprehensive score of the candidate deicing path.

Exemplarily, the emergency supervision and management platform may determine the comprehensive score ξ of the candidate path via Formula (8):

$$ξ = {\sum }_{i = 1}^{N} [ {Φ}_{i} \times ( N - {P}_{i} ) ] , \qquad ( 8 )$$

wherein ξ is the comprehensive score of the candidate path, Φᵢ is the score of the road segment i, N is the total count of road segments included in the candidate path, and Pᵢ is a deicing order of the road segment i in the candidate path. For example, if the road segment i is the third road segment to be deiced in the candidate path, then Pᵢ is 3.

In some embodiments, the emergency supervision and management platform may select the candidate deicing path having the highest comprehensive score as the deicing path.

In some embodiments of the present disclosure, the emergency supervision and management platform determines a plurality of candidate deicing paths for the target road based on the ice formation risk sequence and the location of the supply station of the deicing agent; and determines the deicing path based on the plurality of candidate deicing paths, the service priority, and the real-time traffic data. Under a circumstance where multiple roads are iced and deicing resources are limited, this enables the automatic deicing vehicle to be dispatched preferentially to key road segments such as a main road and an ambulance passage for performing the deicing operation, while avoiding congested road segments with relatively large traffic volumes as much as possible, thereby ensuring an operation efficiency of the automatic deicing vehicle.

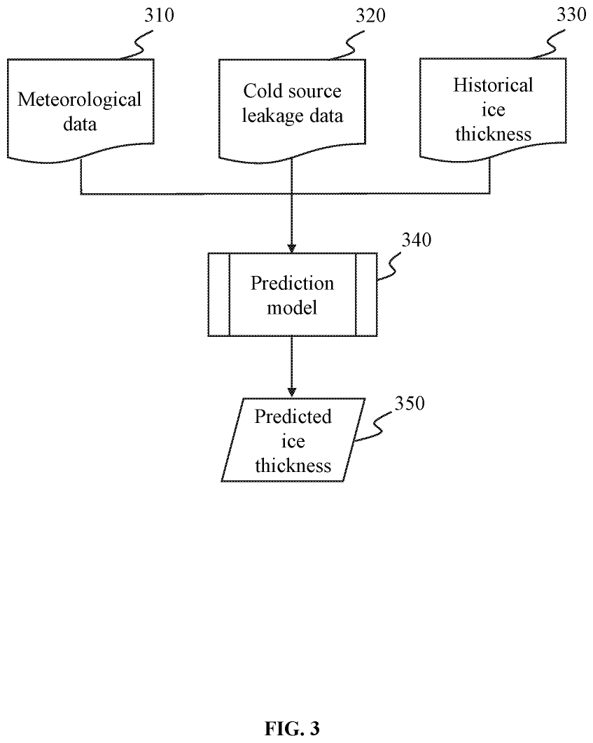

FIG. 3 is a model schematic diagram of a predictive model according to some embodiments of the present disclosure.

In some embodiments, a target road includes a high-risk segment and an ordinary segment, and the emergency supervision and management platform is further configured to determine the high-risk segment based on an ice formation risk sequence; determine a predicted ice thickness 350 of the high-risk segment based on meteorological data 310, cold source leakage data 320, and a historical ice thickness 330; and determine a high-risk deicing parameter based on the predicted ice thickness of the high-risk segment, historical traffic data, and slope information via a preset deicing table.

The high-risk segment refers to a road segment in the target road that has a relatively high ice formation risk and is prone to a traffic accident. In some embodiments, the emergency supervision and management platform may determine a road segment having an ice formation risk value greater than a preset risk threshold as the high-risk segment. The preset risk threshold may be preset based on empricial experience. The high-risk deicing parameter is a deicing parameter applicable to high-risk road segments.

In some embodiments, the emergency supervision and management platform may dynamically adjust the preset risk threshold based on factors such as a meteorological warning and a time period. For example, during a rainstorm warning and a morning or evening peak hour, the emergency supervision and management platform may appropriately lower the preset risk threshold.

In some embodiments, the emergency supervision and management platform may determine the predicted ice thickness of the high-risk segment based on the meteorological data, the cold source leakage data, and the historical ice thickness.

The historical ice thickness refers to an ice thickness of the high-risk segment at a historical time point. In some embodiments, the emergency supervision and management platform may retrieve the historical ice thickness from a storage medium. The ice thicknesses of road segments at each historical time point may be represented as a sequence, for example, [L₁, L₂, . . . , Lₙ], wherein Lₙ is the ice thickness of a road segment n. For determining the ice thickness, see Formula (1) and description thereof. For further content regarding the meteorological data and the cold source leakage data, see the relevant part of the multi-source monitoring data in FIG. 1.

The predicted ice thickness refers to an ice thickness of the target road at a future time point. In some embodiments, the emergency supervision and management platform may determine the predicted ice thickness of the high-risk segment via a prediction model 340.

The prediction model refers to a model used configured to determine the predicted ice thickness. In some embodiments, the prediction model is a machine learning model, for example, any one or a combination of an RNN model, another customized model structure, or the like.

In some embodiments, an input of the prediction model includes the meteorological data, the cold source leakage data, and the historical ice thickness of the high-risk segment, and an output of the prediction model includes the predicted ice thickness of the high-risk segment.

In some embodiments, the emergency supervision and management platform may preprocess the input of the prediction model. For example, the emergency supervision and management platform may perform dimensionless processing on the meteorological data, the cold source leakage data, and the historical ice thickness of the high-risk segment; perform One-Hot Encoding on discrete data; perform normalization processing on continuous data; and fuse multi-source and heterogeneous data, thereby providing a high-quality input for the prediction model.

In some embodiments, the emergency supervision and management platform may train an initial prediction model based on a second training set to obtain the prediction model. The second training set includes a large number of second training samples with second labels. A second training sample may include sample meteorological data, sample cold source leakage data, and a sample historical ice thickness of a sample high-risk segment. The second label is a sample predicted ice thickness corresponding to the second training sample.

In some embodiments, the second training samples with the second labels may be obtained through historical data. For example, for a given detection point a on a road segment i, the emergency supervision and management platform may retrieve, from a storage medium, historical meteorological data, historical cold source leakage data, and a historical ice thickness of the road segment i at a first time point as the second training sample, and retrieve a historical ice thickness of the detection point a at a second time point as the second label, wherein the first time point is earlier than the second time point and both are historical time points. The emergency supervision and management platform may obtain the historical ice thickness of the detection point a based on a historical detection record of the ultrasonic probe. By repeating this step, a large number of the second training samples with second labels may be obtained.

The manner of training the initial prediction model based on the second training set to obtain the prediction model is similar to the manner of training the initial prediction model based on the first training set to obtain the prediction model, and reference may be made to the relevant content of the prediction model described above.

In some embodiments, the emergency supervision and management platform may determine the high-risk deicing parameter based on the predicted ice thickness of the high-risk segment, the historical traffic data, and the slope information via the preset deicing table.

The historical traffic data is similar to the real-time traffic data, with a difference being that the historical traffic data is traffic data at a historical time point, while the real-time traffic data is traffic data of a current state. The high-risk deicing parameter is a deicing parameter applicable to the high-risk segment. More descriptions regarding the real-time traffic data, the slope information, and the deicing parameter may be found in related descriptions of FIG. 1.

In some embodiments, the emergency supervision and management platform may further determine the high-risk deicing parameter by querying a preset deicing table. The preset deicing table includes a correspondence between high-risk deicing parameters and predicted ice thicknesses of high-risk road segments, historical traffic data, and slope information.

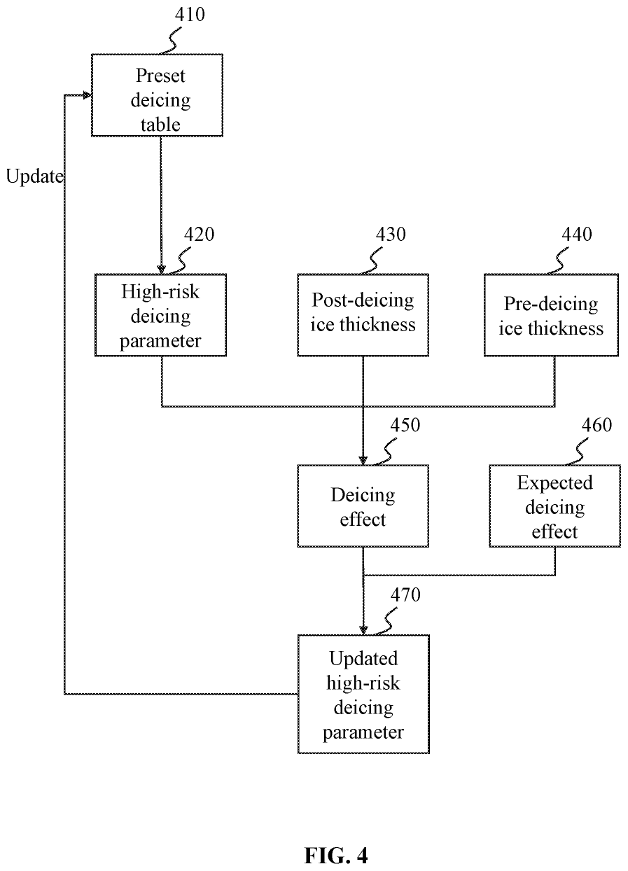

In some embodiments, the preset deicing table further includes predicted traffic data of high-risk segments. When the predicted traffic data is included, the preset deicing table includes a correspondence between high-risk deicing parameters and predicted ice thicknesses of high-risk road segments, predicted traffic data, historical traffic data, and slope information. More descriptions regarding the predicted ice thickness may be found in related descriptions of FIG. 4.

In some embodiments, the preset deicing table may be constructed based on historical data. For example, for the preset deicing table, a plurality of historical deicing records with satisfactory deicing effects may be retrieved from a storage medium. For a particular historical deicing record, the emergency supervision and management platform may determine a historical ice thickness, historical traffic data, and historical slope information of a historical high-risk segment as the predicted ice thickness, the historical traffic data, and the slope information in the preset deicing table; and determine a historical deicing parameter for the historical high-risk segment as the corresponding high-risk deicing parameter. By repeating this step, the preset deicing table may be constructed. When a historical ice thickness after deicing is less than a preset thickness, the emergency supervision and management platform may consider that the deicing effect of the historical deicing record is satisfactory.

A processor of the the emergency supervision and management platform may determine a current high-risk deicing parameter according to a current predicted ice thickness, the historical traffic data, and the slope information by consulting the preset deicing table.

In some embodiments, the emergency supervision and management platform may further update the preset deicing table. For further description regarding this part, see FIG. 4 and related content thereof.

In some embodiments of the present disclosure, since a high-risk segment has a greater potential risk of causing a traffic accident compared with an ordinary segment, if the high-risk segment and the ordinary segment are not distinguished during the deicing operation, an imbalance in resource allocation and low deicing efficiency may result, making it difficult to quickly eliminate an ice formation hazard of the high-risk segment. The present solution determines the high-risk segment based on the ice formation risk sequence, and determines the predicted ice thickness of the high-risk segment based on the meteorological data, the cold source leakage data, and the historical ice thickness, thereby accurately quantifying an ice formation development trend of the high-risk segment. This helps improve a prediction accuracy of the high-risk deicing parameter and achieve precise deployment of the deicing agent, which not only avoids resource waste and environmental pollution caused by an excessive amount of the deicing agent, but also avoids a problem of incomplete deicing caused by an insufficient amount of the deicing agent.

FIG. 4 is a schematic diagram illustrating update of a deicing parameter according to some embodiments of the present disclosure.

In some embodiments, the emergency supervision and management platform may determine predicted traffic data of a high-risk segment based on real-time traffic data; and determine a high-risk deicing parameter 420 based on a predicted ice thickness, historical traffic data of the high-risk segment, the predicted traffic data, and slope information via a preset deicing table 410.

The predicted traffic data is similar to the real-time traffic data, with a difference being that the predicted traffic data is traffic data at a future time point, while the real-time traffic data is traffic data of a current state. For further content regarding the real-time traffic data, see related description of FIG. 1.

In some embodiments, the emergency supervision and management platform may determine the predicted traffic data of the high-risk segment by querying a second vector database based on the real-time traffic data.

In some embodiments, the emergency supervision and management platform may construct the second vector database based on historical data, and determine the predicted traffic data based on a matching vector retrieval. The second vector database includes a plurality of reference vectors with labels, a reference vector is constructed based on historical traffic data at a first time point, and a label is historical traffic data at a second time point. The first time point is earlier than the second time point and both are historical time points. In some embodiments, the emergency supervision and management platform may construct a vector to be matched based on the real-time traffic data of the high-risk segment. There may be multiple ways to construct the reference vector and the vector to be matched. For example, the vector to be matched is constructed using manners such as One-Hot, Word2Vec, or the like.

In some embodiments, the emergency supervision and management platform may obtain multiple segments of historical traffic data from a storage medium. For a given segment of historical traffic data, the emergency supervision and management platform may construct a reference vector based on the historical traffic data at the first time point, and determine the historical traffic data at the second time point as the label of the reference vector. By repeating this step, a plurality of reference vectors with labels are constructed.

In some embodiments, the emergency supervision and management platform may determine the predicted traffic data based on similarities between the vector to be matched and the plurality of reference vectors in the second vector database. For example, a reference vector having a similarity with the vector to be matched that satisfies a similarity preset condition is taken as a target vector, and historical traffic data at the second time point corresponding to the target vector is determined as the predicted traffic data. The similarity preset condition includes a maximum similarity, a similarity greater than a preset threshold, or the like.

In some embodiments, the emergency supervision and management platform may determine the high-risk deicing parameter based on the predicted ice thickness, the historical traffic data of the high-risk segment, the predicted traffic data, and the slope information via the preset deicing table. In some embodiments, the emergency supervision and management platform may introduce the predicted traffic data into the preset deicing table constructed above, thereby constructing a preset deicing table that includes a correspondence between high-risk deicing parameters and predicted ice thicknesses of high-risk road segments, predicted traffic data, historical traffic data, and slope information.

In some embodiments of the present disclosure, the predicted traffic data of the high-risk segment is determined based on the real-time traffic data; and the high-risk deicing parameter is determined based on the predicted ice thickness, the historical traffic data of the high-risk segment, the predicted traffic data, and the slope information via the preset deicing table. By introducing the traffic volume of the high-risk segment, the emergency supervision and management platform is enabled to proactively respond to an upcoming traffic volume, timely spread a sufficient amount of the deicing agent before a traffic peak arrives to reduce a traffic hazard of the high-risk segment, and appropriately reduce a spreading amount before a traffic trough arrives to save the deicing agent, thereby achieving intelligent allocation of deicing resources.

In some embodiments, the emergency supervision and management platform may determine a deicing effect 450 of the high-risk deicing parameter based on the high-risk deicing parameter, a pre-deicing ice thickness 440 of the high-risk segment, and a post-deicing ice thickness 430. Based on the deicing effect 450, the high-risk deicing parameter is adjusted and the preset deicing table 410 is updated.

The pre-deicing ice thickness and the post-deicing ice thickness refer to ice thicknesses before and after a deicing operation, respectively. In some embodiments, the emergency supervision and management platform may measure the pre-deicing ice thickness via an ultrasonic probe of an automatic deicing vehicle. After completing the deicing operation, the emergency supervision and management platform may control the automatic deicing vehicle to travel along the same deicing path again to measure the post-deicing ice thickness. For how to determine the ice thickness, see Formula (1) in FIG. 1 and related content thereof.

The deicing effect 450 may reflect a degree of superiority of a current deicing parameter.

In some embodiments, the deicing effect is positively correlated with a difference between the pre-deicing ice thickness and the post-deicing ice thickness. After the deicing operation, the greater the difference between the pre-deicing ice thickness and the post-deicing ice thickness, the less residual ice remains on the road surface, and the better the deicing effect.

Exemplarily, the emergency supervision and management platform may determine the deicing effect via Formula (9):

$$τ = {k}_{6} \times \frac{{L}_{α} - {L}_{β}}{{L}_{α}} , \qquad ( 9 )$$

wherein τ denotes the deicing effect, L_{α} denotes the pre-deicing ice thickness, L_{β} denotes the post-deicing ice thickness, and k₆ is a coefficient, wherein a value of the coefficient k₆ may be preset based on prior experience.

In some embodiments, the emergency supervision and management platform may dynamically adjust the high-risk deicing parameter according to an expected deicing effect 460 and the deicing effect 450 to obtain the updated high-risk deicing parameter 470, and update the preset deicing table based on the updated high-risk deicing parameter 470.

The expected deicing effect is an idealized deicing effect. The emergency supervision and management platform may preset the expected deicing effect based on prior experience.

In some embodiments, since the high-risk segment has a higher potential risk compared with an ordinary segment, the expected deicing effect of the high-risk segment is higher than that of the ordinary segment; and to ensure timeliness of the deicing operation, the expected deicing effect of a road segment with a relatively high pre-deicing ice thickness is higher than that of a road segment with a relatively low pre-deicing ice thickness.

In some embodiments, when the deicing effect 450 is much smaller than the expected deicing effect (e.g., the expected deicing effect minus the deicing effect being greater than a preset difference threshold), it indicates that the currently used deicing parameter cannot meet requirements, and the high-risk deicing parameter needs to be readjusted and the preset deicing table needs to be updated.

In some embodiments, an adjustment magnitude of the spreading amount and the spreading rate in the high-risk deicing parameter 420 is positively correlated with a magnitude by which the deicing effect 450 deviates from the expected deicing effect 460. After the adjustment of the high-risk deicing parameter 420 is completed, the updated high-risk deicing parameter 470 may be obtained accordingly.

Exemplarily, the emergency supervision and management platform may determine an updated spreading amount and an updated spreading rate via Formulas (10) and (11):

$$C = \overline{\overline{C}} \times ( 1 + {τ}_{L} - {τ}_{S} ) \qquad ( 10 )$$

$$D = \overline{\overline{D}} \times ( 1 + {τ}_{L} - {τ}_{S} ) , \qquad ( 11 )$$

wherein C denotes an updated spreading amount, C̅ denotes an original spreading amount, D denotes an updated spreading rate, D̅ denotes an original spreading rate, τ_{L} denotes the expected deicing effect, and τ_{S} denotes the deicing effect. More descriptions regarding the spreading amount and the spreading rate may be found in FIG. 1 and related descriptions thereof.

In some embodiments, after determining the updated spreading amount and the updated spreading rate, the emergency supervision and management platform may overwrite the original spreading amount and the original spreading rate in the preset deicing table therewith, thereby updating the preset deicing table.

In some embodiments of the present disclosure, the deicing effect of the high-risk deicing parameter is determined based on the high-risk deicing parameter, the pre-deicing ice thickness of the high-risk segment, and the post-deicing ice thickness; and based on the deicing effect, the high-risk deicing parameter is adjusted and the preset deicing table is updated. The high-risk deicing parameter can be evaluated and optimized based on the deicing effect 450, thereby achieving iterative updating of the preset deicing table and ensuring accuracy and applicability of the preset deicing table.

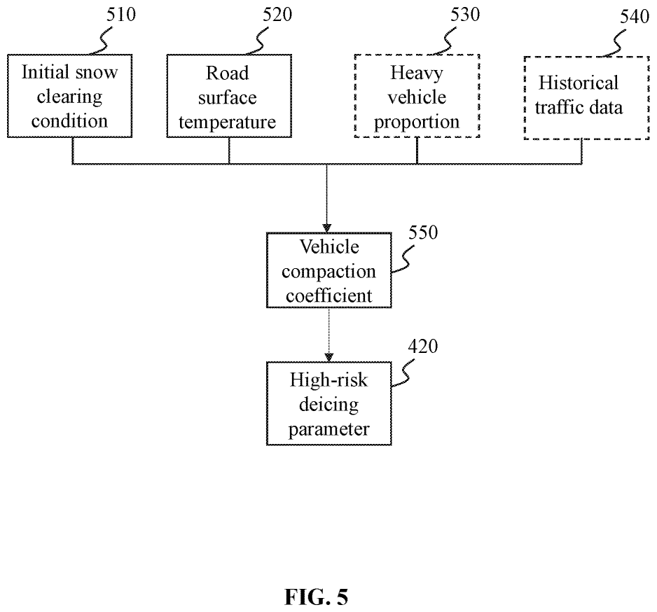

FIG. 5 is a schematic diagram illustrating adjustment of a high-risk deicing parameter according to some embodiments of the present disclosure.

In some embodiments, the emergency supervision and management platform may determine a vehicle compaction coefficient 550 based on a road surface temperature 520 and an initial snow clearing condition 510 of a high-risk segment, and adjust the high-risk deicing parameter 420 based on the vehicle compaction coefficient.

The road surface temperature refers to a temperature of a road surface. In some embodiments, the road surface temperature may be acquired via a temperature sensor on the road surface.

The initial snow clearing condition may reflect whether snow on a road segment has been cleaned. The initial snow clearing condition may include a cleaning time, a cleaned road segment, or the like. The initial snow clearing condition may be automatically uploaded to the emergency supervision and management platform by a cleaner, a snowplow vehicle, or the like.

The vehicle compaction coefficient may quantify a dual impact of traffic rolling on an ice formation process: on one hand, heat generated by tire pressure and rolling friction can disrupt a crystal structure of an ice layer, thereby improving deicing efficiency; on the other hand, traffic volume can compact a loose snow layer to form high-density compacted snow or glaze ice, which makes penetration of the deicing agent difficult and reduces deicing efficiency. Therefore, when the road surface temperature and the initial snow clearing condition change, a direction of action of the vehicle compaction coefficient may also change accordingly.

In some embodiments, the emergency supervision and management platform may determine the vehicle compaction coefficient via a second preset table based on the road surface temperature and the initial snow clearing condition of the high-risk segment.

The second preset table may be constructed based on prior experience, and the second preset table includes a correspondence between road surface temperatures, initial snow clearing conditions, and different vehicle compaction coefficients. For example, the correspondence may be as follows: when the road surface temperature is greater than 0° C. and the initial snow has been cleared, a positive effect of the vehicle compaction coefficient is greater and is more conducive to deicing; the vehicle compaction coefficient may be set to be less than 1, and an amount of deicing agent applied may be appropriately reduced. When the road surface temperature is lower than −5° C. and the initial snow has not been cleared, a negative effect of the vehicle compaction coefficient is greater, reducing deicing efficiency; the vehicle compaction coefficient may be set to be greater than 1, and the amount of deicing agent applied may be appropriately increased. The emergency supervision and management platform may determine the vehicle compaction coefficient by querying the second preset table.

In some embodiments, the emergency supervision and management platform may adjust the vehicle compaction coefficient based on a heavy vehicle proportion 530 passing through the high-risk segment and historical traffic data 540.

The heavy vehicle proportion refers to a ratio of heavy vehicles (e.g., a truck, a bus, etc.) passing through the high-risk segment to total vehicles. The emergency supervision and management platform may acquire a total count of vehicles and a count of heavy vehicles passing through the high-risk segment per unit time based on a RSU unit, thereby determining the heavy vehicle proportion. More descriptions regarding the RSU unit may be found in related descriptions of FIG. 1.

In some embodiments, heavy vehicles exert a stronger compaction effect on accumulated snow than ordinary vehicles; therefore, the vehicle compaction coefficient needs to be corrected based on the proportion of heavy vehicles. Similarly, when an excessive number of vehicles have previously compacted the snow or when vehicles are traveling at excessive speeds, the icing formation process is also significantly affected; therefore, the vehicle compaction coefficient needs to be corrected based on the historical traffic data.

In some embodiments, when the vehicle compaction coefficient is greater than 1, the greater the proportion of heavy vehicles and the greater an average historical vehicle speed and an average historical traffic volume in the historical traffic data, the greater an increase magnitude of the vehicle compaction coefficient. When the vehicle compaction coefficient is less than 1, the greater the proportion of heavy vehicles and the greater the average historical vehicle speed and the average historical traffic volume in the historical traffic data, the greater a decrease magnitude of the vehicle compaction coefficient.

In some embodiments of the present disclosure, by adjusting the vehicle compaction coefficient based on the proportion of heavy vehicles passing through the high-risk road segment and the historical traffic data, and further introducing parameters such as the proportion of heavy vehicles, the vehicle speed, and the traffic volume to correct the vehicle compaction coefficient on the basis thereof, the accuracy of the vehicle compaction coefficient can be improved, thereby avoiding excessive or insufficient application of deicing agents caused by estimation deviations.

In some embodiments, the emergency supervision and management platform adjusts the high-risk deicing parameter based on the vehicle compaction coefficient. For example, when the vehicle compaction coefficient is greater than 1, the emergency supervision and management platform may appropriately increase the high-risk deicing parameter; when the vehicle compaction coefficient is less than 1, the emergency supervision and management platform may appropriately decrease the high-risk deicing parameter. As another example, the emergency supervision and management platform may determine a product of original high-risk deicing parameter and the vehicle compaction coefficient as an adjusted deicing parameter.

In some embodiments of the present disclosure, the vehicle compaction coefficient is determined based on the road surface temperature and the initial snow clearing condition of the high-risk road segment, and the high-risk deicing parameter is adjusted based on the vehicle compaction coefficient, thereby quantifying complex physical effects of vehicle compaction on an icing formation process and overcoming limitations of conventional decision-making that neglect dynamic effects of traffic volume. By means of the vehicle compaction coefficient, the system can intelligently determine, based on actual road conditions, an influence of compaction behavior on the deicing operation and flexibly adjust the deicing parameter, thereby helping improve deicing efficiency and reduce consumption of the deicing agent.

The basic concepts have been described above. Obviously, for those skilled in the art, the detailed disclosure above is merely illustrative and does not constitute a limitation on the present disclosure. Although not explicitly stated, those skilled in the art may make various modifications, improvements, and corrections to the present disclosure. Such modifications, improvements, and corrections are suggested within the present disclosure and thus remain within the spirit and scope of the exemplary embodiments of the present disclosure.

Meanwhile, the present disclosure uses specific terms to describe the embodiments herein. Terms such as “one embodiment,” “an embodiment,” and/or “some embodiments” mean that a given feature, structure, or characteristic related to at least one embodiment of the present disclosure. Therefore, it is emphasized and noted that the terms “an embodiment,” “one embodiment,” or “an alternative embodiment” mentioned two or more times at different locations in the present disclosure do not necessarily refer to the same embodiment. Furthermore, certain features, structures, or characteristics in one or more embodiments of the present disclosure may be appropriately combined.

Furthermore, unless explicitly stated in the claims, the order of processing elements and sequences, the use of numbers or letters, or the use of other names in the present disclosure is not intended to limit the order of the processes and methods described herein. Although the foregoing disclosure discusses some currently considered useful inventive embodiments through various examples, it should be understood that such details are for illustrative purposes only, and the appended claims are not limited to the disclosed embodiments. On the contrary, the claims are intended to cover all modifications and equivalent combinations that conform to the essence and scope of the embodiments of the present disclosure. For example, although the system components described above may be implemented via hardware devices, they may also be realized solely through software solutions, such as installing the described system on existing servers or mobile devices.

Similarly, it should be noted that to simplify the presentation of the present disclosure and thereby aid in understanding one or more inventive embodiments, in the descriptions of the embodiments of the present disclosure above, various features may sometimes be grouped into a single embodiment, figure, or description thereof. However, this disclosure manner does not imply that the subject matter of the present disclosure requires more features than those mentioned in the claims. In fact, the features of an embodiment are fewer than all the features of a single embodiment disclosed above.

In some embodiments, numbers describing quantities or attributes are used. It should be understood that such numbers used in the description of the embodiments may, in some examples, be modified by the terms “approximately,” “about,” or “substantially.” Unless otherwise specified, “approximately,” “about,” or “substantially” indicates that the stated number allows for a variation of ±20%. Accordingly, in some embodiments, the numerical parameters used in the specification and claims are approximations, which may vary depending on the characteristics required by individual embodiments. In some embodiments, numerical parameters should consider the specified number of significant digits and adopt the method of general digit retention. Although the numerical ranges and parameters used to confirm their breadth in some embodiments of the present disclosure are approximations, in specific embodiments, such numerical values are set as accurately as possible within the feasible range.

For each patent, patent application, patent application publication, and other material, such as articles, books, specifications, publications, documents, etc., cited in the present disclosure, the entire content thereof is hereby incorporated by reference into the present disclosure. Excluded are application history documents that are inconsistent or conflict with the content of the present disclosure, and documents that limit the broadest scope of the claims of the present disclosure (whether currently or subsequently appended to the present disclosure). It should be noted that if the description, definition, and/or use of terms in the supplementary materials of the present disclosure are inconsistent or conflict with those in the present disclosure, the description, definition, and/or use of terms in the present disclosure shall prevail.

Finally, it should be understood that the embodiments described in the present disclosure are merely illustrative of the principles of the embodiments of the present disclosure. Other variations may also fall within the scope of the present disclosure. Therefore, by way of example and not limitation, alternative configurations of the embodiments of the present disclosure may be considered consistent with the teachings of the present disclosure. Accordingly, the embodiments of the present disclosure are not limited to those explicitly introduced and described herein.

What is claimed is:

1. A system for emergency warning of road icing based on an Internet of Things (IoT) large model, comprising: an emergency supervision and management platform, wherein the emergency supervision and management platform is configured to perform operations including:
obtaining multi-source monitoring data of a target road;
determining, based on the multi-source monitoring data, a road surface material, road elevation information, and slope information, an ice formation risk sequence of the target road;
determining, based on the ice formation risk sequence, a deicing parameter for the target road, wherein the deicing parameter includes a type, a spreading amount, and a spreading rate of a deicing agent;
controlling, based on the deicing parameter, an automatic deicing vehicle to travel to the target road, measuring a pre-deicing ice thickness by transmitting an acoustic wave and receiving echoes via an ultrasonic probe of the automatic deicing vehicle, and uploading the pre-deicing ice thickness to the emergency supervision and management platform; and,
controlling, based on the deicing parameter, the automatic deicing vehicle to spread the deicing agent on the target road, and controlling a road condition information display at an entrance of the target road to display warning information.

2. The system according to claim 1, wherein the multi-source monitoring data further includes a vegetation density on two sides of the target road, and the vegetation density is acquired by a remote sensing satellite.

3. The system according to claim 1, wherein the emergency supervision and management platform is further configured to perform operations including:
determining, based on the ice formation risk sequence and a location of a supply station of the deicing agent, a plurality of candidate deicing paths for the target road; and
determining, based on the plurality of candidate deicing paths, a service priority, and real-time traffic data, a deicing path.

4. The system according to claim 1, wherein the target road includes a high-risk segment and an ordinary segment, and the emergency supervision and management platform is further configured to perform operations including:
determining, based on the ice formation risk sequence, the high-risk segment;
determining, based on meteorological data, cold source leakage data, and a historical ice thickness, a predicted ice thickness of the high-risk segment; and
determining, based on the predicted ice thickness of the high-risk segment, historical traffic data, and the slope information via a preset deicing table, a high-risk deicing parameter.

5. The system according to claim 4, wherein the emergency supervision and management platform is further configured to perform operations including:
determining, based on the real-time traffic data, predicted traffic data of the high-risk segment; and
determining, based on the predicted ice thickness, the historical traffic data of the high-risk segment, the predicted traffic data, and the slope information via the preset deicing table, the high-risk deicing parameter.

6. The system according to claim 4, wherein the emergency supervision and management platform is further configured to perform operations including:
determining, based on the high-risk deicing parameter, the pre-deicing ice thickness of the high-risk segment, and an ice thickness after deicing, a deicing effect of the high-risk deicing parameter; and
adjusting, based on the deicing effect, the high-risk deicing parameter, and updating the preset deicing table.

7. The system according to claim 4, wherein the emergency supervision and management platform is further configured to perform operations including:
determining, based on a road surface temperature and an initial snow clearing condition of the high-risk segment, a vehicle compaction coefficient; and
adjusting, based on the vehicle compaction coefficient, the high-risk deicing parameter.

8. The system according to claim 7, wherein the emergency supervision and management platform is further configured to perform operations including:
adjusting, based on a heavy vehicle proportion passing the high-risk segment and the historical traffic data, the vehicle compaction coefficient.

9. The system according to claim 1, wherein the emergency supervision and management platform is further configured to perform operations including:
determining, based on the pre-deicing ice thickness of the target road and a coefficient of friction, a traffic volume limit value and a speed limit value of the target road; and
controlling, based on the traffic volume limit value and the speed limit value, a traffic signal device to limit a traffic volume and a speed for vehicles passing the target road, and planning a dedicated deicing lane for the automatic deicing vehicle.

10. A method for emergency warning of road icing, executed based on a system for emergency warning of road icing based on an Internet of Things (IoT) large model, the method comprising:
obtaining multi-source monitoring data of a target road;
determining, based on the multi-source monitoring data, a road surface material, road elevation information, and slope information, an ice formation risk sequence of the target road;
determining, based on the ice formation risk sequence, a deicing parameter for the target road, wherein the deicing parameter includes a type, a spreading amount, and a spreading rate of a deicing agent;
controlling, based on the deicing parameter, an automatic deicing vehicle to travel to the target road, measuring a pre-deicing ice thickness by transmitting an acoustic wave and receiving echoes via an ultrasonic probe of the automatic deicing vehicle, and uploading the pre-deicing ice thickness back to an emergency supervision and management platform; and,
controlling, based on the deicing parameter, the automatic deicing vehicle to spread the deicing agent on the target road, and controlling a road condition information display at an entrance of the target road to display warning information.

11. The method according to claim 10, wherein the multi-source monitoring data further includes a vegetation density on two sides of the target road, and the vegetation density is acquired by a remote sensing satellite.

12. The method according to claim 10, further comprising:
determining, based on the ice formation risk sequence and a location of a supply station of the deicing agent, a plurality of candidate deicing paths for the target road; and
determining, based on the plurality of candidate deicing paths, a service priority, and real-time traffic data, a deicing path.

13. The method according to claim 10, wherein the target road includes a high-risk segment and an ordinary segment, and the determining a deicing parameter for the target road based on the ice formation risk sequence comprises:
determining, based on the ice formation risk sequence, the high-risk segment;
determining, based on meteorological data, cold source leakage data, and historical ice thickness, a predicted ice thickness of the high-risk segment; and
determining, based on the predicted ice thickness of the high-risk segment, historical traffic data, and the slope information via a preset deicing table, a high-risk deicing parameter.

14. The method according to claim 13, further comprising:
determining, based on the real-time traffic data, predicted traffic data of the high-risk segment; and
determining, based on the predicted ice thickness, the historical traffic data of the high-risk segment, the predicted traffic data, and the slope information via the preset deicing table, the high-risk deicing parameter.

15. The method according to claim 13, further comprising:
determining, based on the high-risk deicing parameter, the pre-deicing ice thickness of the high-risk segment, and an ice thickness after deicing, a deicing effect of the high-risk deicing parameter; and
adjusting, based on the deicing effect, the high-risk deicing parameter and updating the preset deicing table.

16. The method according to claim 13, further comprising:
determining, based on the road surface temperature and the initial snow clearing condition of the high-risk segment, a vehicle compaction coefficient; and
adjusting, based on the vehicle compaction coefficient, the high-risk deicing parameters.

17. The method according to claim 16, further comprising:
adjusting, based on the heavy vehicle proportion passing through the high-risk segment and the historical traffic data, the vehicle compaction coefficient.

18. The method according to claim 10, further comprising:
determining, based on the pre-deicing ice thickness and the coefficient of friction of the target road, a traffic volume limit value and a speed limit value of the target road; and
controlling, based on the traffic volume limit value and the speed limit value, a traffic signal device to limit a traffic volume and a speed of vehicles passing through the target road, and planning a dedicated deicing lane for the automatic deicing vehicle.

19. A non-transitory computer-readable storage medium, wherein the storage medium stores computer instructions, and when a computer reads the computer instructions in the storage medium, the computer executes a method for emergency warning of road icing, the method comprising:
obtaining multi-source monitoring data of a target road;
determining, based on the multi-source monitoring data, a road surface material, road elevation information, and slope information, an ice formation risk sequence of the target road;
determining, based on the ice formation risk sequence, a deicing parameter for the target road, wherein the deicing parameter includes a type, a spreading amount, and a spreading rate of a deicing agent;
controlling, based on the deicing parameter, an automatic deicing vehicle to travel to the target road, measuring a pre-deicing ice thickness by transmitting an acoustic wave and receiving echoes via an ultrasonic probe of the automatic deicing vehicle, and uploading the pre-deicing ice thickness back to an emergency supervision and management platform; and,
controlling, based on the deicing parameter, the automatic deicing vehicle to spread the deicing agent on the target road, and controlling a road condition information display at an entrance of the target road to display warning information.
